(19) United States
(12) Patent Application Publication
(10) Pub. No.: US 2010/0007818 A1
(43) Pub. Date: Jan. 14, 2010

(54) ILLUMINATION APPARATUS, ILLUMINATING METHOD AND DISPLAY APPARATUS

(75) Inventors: Goroh Saitoh, Minato-ku (JP); Masao Imai, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Minato-ku Tokyo (JP)

(21) Appl. No.: 12/305,457

(22) PCT Filed: Jun. 18, 2007
(86) PCT No.: PCT/JP2007/062230

§ 371 Date: Dec. 18, 2008

(30) Foreign Application Priority Data
Jun. 20, 2006 (JP) 2006 170740

(51) Int. Cl. G02F 1/1335; F21V 7/22

(52) U.S. Cl. 349/61; 362/606

(57) ABSTRACT

A light source is arranged at a side face of a light guide plate, and a beam direction regulator and a reflection plate are sequentially arranged at a side of the light guide plate opposite to an illumination direction. Furthermore, a transmittance/scattering switching device is arranged at an illumination direction side of the light guide plate. Light from the light source entering the light guide plate emerges in a direction opposite to the illumination direction, passes through the beam direction regulator, and is reflected by the reflection plate. The reflected light once again passes through the beam direction regulator, passes through the light guide plate, enters the transmittance/scattering switching device, and then emerges as light in a transmitting state or a scattering state. Thus, the occurrence of moiré effects and uneven luminance are suppressed, and an illumination apparatus capable of controlling an emerging light angular distribution is obtained.

### TECHNICAL FIELD

The present invention relates to an illumination apparatus, a method for illuminating, and a display apparatus capable of controlling an emerging light angle, and in particular to a thin and highly visible illumination apparatus, a backlight for a display apparatus, and also a display apparatus comprising the illumination apparatus.

### BACKGROUND ART

Recently, display panels are widely used in large terminals such as televisions, mid-sized terminals such as notebook-sized personal computers and cash dispensers, and also in small sized terminals such as mobile telephones and portable game machines. In particular, display apparatuses using liquid crystal display panels have advantages such as being thin and lightweight with low power consumption, and are mounted in many terminal devices.

Conventionally, a narrow viewing angle was considered to be one disadvantage of liquid crystal display panels; but in-plane switching methods, vertical alignment modes, and the like have become practical; and currently, wide viewing angle displays are possible. Liquid crystal display panels capable of wide viewing angle displays are mounted not only in large terminals such as televisions, but even in portable/small sized terminals (mobile telephones, portable game machines, etc.) used for viewing by multiple persons and information sharing despite compact sizes. On the other hand, display apparatuses with narrow viewing angles are desirable for such portable/small sized terminals and mid-sized terminals (notebook-sized personal computers, cash dispensers, etc.) to provide privacy and confidentiality. Therefore, a display apparatus capable of switching between a narrow viewing angle display and a wide viewing angle display, i.e., a display apparatus capable of switching a viewing angle (viewing angle control), is desirable.

A liquid crystal display apparatus comprising an illumination apparatus according to Patent Literature 1 is an example of a display apparatus capable of a viewing angle control such as that recited above. The conventional viewing angle control liquid crystal display apparatus according to Patent Literature 1 comprises a liquid crystal display device, a scattering control device (scattering control means), and an illumination apparatus; and the scattering control device is arranged between the liquid crystal display device and the illumination apparatus. FIG. 31 is a perspective view illustrating the conventional illumination apparatus according to Patent Literature 1. As illustrated in FIG. 31, an illumination apparatus 125 is arranged below a scattering control device 126 and comprises a sheet with light shielding slits 120 and an irradiation unit 121. A light source 122 is arranged in the irradiation unit 121; and further, a light emergence face 123 for guiding light emerging from the light source 122 to the sheet with light shielding slits 120, and a reflection sheet 124 arranged on a face opposing the light emergence face for reflecting light from the light source 122 are also arranged therein. The sheet with light shielding slits 120 comprises multiple light shielding materials arranged mutually parallel on one face of a transparent sheet, wherein the extension direction of the light shielding materials is the same as a direction perpendicular to the display unit.

In the conventional illumination apparatus according to Patent Literature 1 thus configured, an emerging light angular distribution of light emerging from the irradiation unit 121 is made narrow (highly parallel light) by the sheet with light shielding slits 120, after which the emerging light angular distribution is controlled (controlled into highly parallel emerging light and scattered light) by the scattering control device (scattering control means) 126. In other words, the scattering control device 126 controls the scattering of incident beams according to an existence or absence of an applied electrical potential; and therefore when the scattering control device 126 is in a scattering state, the light emerging from the scattering control device 126 is light of a wide viewing angle; and when the scattering control device 126 is in a transparent state, the light emerging from the scattering control device 126 is light of a narrow viewing angle. According to Patent Literature 1, the illumination apparatus controls the emerging light angular distribution and thereby controls the viewing angle of the liquid crystal display apparatus.

However, in the conventional viewing angle control liquid crystal display apparatus according to Patent Literature 1, as the distance between the liquid crystal display device and the sheet with light shielding slits is small, moiré effects occur due to interference between structural bodies in the liquid crystal display device (such as a black matrix or internal circuitry) and the sheet with light shielding slits; and the visibility markedly declines. Methods for suppressing such moiré effects comprise methods recited in, for example, paragraphs (0024) to (0025) of Patent Literature 2 or FIG. 2 of Patent Literature 2 for inclining a sheet with light shielding slits at a predetermined bias angle. This method suppresses moiré effects by inclining an extension direction of a light shielding material of a sheet with light shielding slits at a predetermined bias angle with respect to a periodic direction of the pixel structure when adhering the sheet with light shielding slits to the liquid crystal display device.

Also, examples of display apparatuses using a beam direction regulator for controlling an emerging light angular distribution such as the sheet with light shielding slits according to Patent Literature 1 comprise a liquid crystal display apparatus according to Patent Literature 3. In this liquid crystal display apparatus, a light control film (light controller) having a reflective processing is arranged between a liquid crystal display unit and a backlight to reflect incident light from a display face side and transmit light from the backlight. By such a configuration, the light from the backlight is used for the display in dark locations; and in bright locations, external light is reflected by the reflective processing of the light control film, and the reflected light is used for the display. Thus, a liquid crystal display apparatus capable of transmitting and reflecting and having highly oriented emerging light (a narrow viewing angle) is realized.

Furthermore, a liquid crystal display apparatus illustrated in FIG. 1 of Patent Literature 4 comprises louvers arranged between a liquid crystal display cell and a light source. Additionally, a liquid crystal display apparatus illustrated in FIG. 4 of Patent Literature 4 comprises louvers arranged on a display face side of a liquid crystal display cell and a reflection plate arranged on an opposing face side thereof. The liquid crystal display apparatus illustrated in FIG. 1 of Patent Literature 4 results in a narrower viewing angle; and the liquid crystal display apparatus illustrated in FIG. 4 of Patent Literature 4 suppresses a diffused reflection of a display apparatus surface of a reflecting liquid crystal display apparatus using external light for the display and improves contrast. Further, technology wherein a reflection plate is arranged on one face of a louver is recited in claim 2 of Patent Literature 4. No detailed description or exemplary embodiment is recited for this claim, but it appears that utilization is possible in a reflecting liquid crystal display apparatus using external light for the display (a modification of the liquid crystal display device illustrated in FIG. 4 of Patent Literature 4).

Patent Literature 1: Japanese Patent No. 3328496

Patent Literature 2: Japanese Patent No. 3675752

Patent Literature 3: Japanese Utility Model Application Laid-Open No. H06-076934

Patent Literature 4: Unexamnined Japanese Patent Application KOKAI Publication No. H01-25123

### DISCLOSURE OF INVENTION

However, the problems indicated below exist for the conventional art recited above.

In the liquid crystal display apparatus according to Patent Literature 1, the distance between the liquid crystal display device and the sheet with light shielding slits is small as recited above, and therefore moiré effects occur and the visibility markedly declines. Also, according to the method of Patent Literature 2 for inclining the sheet with light shielding slits at a predetermined bias angle, although it is possible to somewhat suppress moiré effects, it is difficult to sufficiently suppress moiré effects. In particular, the interference between structural bodies in the liquid crystal display device and the beam direction regulator becomes more complex in the case where the viewing angle is controlled from multiple directions using a beam direction regulator or the like having a polygon or circular transparent region covered by a light absorption region rather than the viewing angle being controlled in only one direction (only the direction perpendicular to the slits) using the sheet with light shielding slits according to Patent Literature 1; and therefore it is exceedingly difficult to suppress moiré effects by a method for inclining the bias angle. Moreover, according to the liquid crystal display apparatus of Patent Literature 1, an unevenness of the luminance of the liquid crystal display apparatus occurs due to unevenness of the width or spacing of light shielding materials of the sheet with light shielding slits, and unfortunately the display quality declines. Additionally, despite even slightly thinner display apparatuses being desirable for portable terminals, the liquid crystal display apparatus according to Patent Literature 1 comprises additions of scattering control means and a light shielding slit sheet and therefore unfortunately becomes thicker than general liquid crystal display apparatuses.

Also, in the liquid crystal display apparatuses according to Patent Literature 3 and Patent Literature 4, moiré effects occur and the visibility unfortunately declines similarly to the liquid crystal display apparatus according to Patent Literature 1. Further, each of the reflection plates arranged in the liquid crystal display apparatuses according to Patent Literature 3 and Patent Literature 4 reflects external light and is used to realize a reflecting liquid crystal display apparatus; and no description is provided regarding suppression of moiré effects and uneven luminance, thickness reductions of display apparatuses, etc.

The present invention was accomplished in consideration of the relevant problems and is directed to provide an illumination apparatus and a method for illuminating capable of controlling an emerging light angular distribution to suppress moiré effects and uneven luminance, and a display apparatus comprising the illumination apparatus and capable of controlling a viewing angle.

An illumination apparatus according to the present invention comprises: a light source; a light guide plate for emitting incident light from the light source in a direction opposite to an illumination direction; a first beam direction regulator arranged at a side of the light guide plate opposite to the illumination direction for regulating a direction of incident light and emitting the light; a reflecting member arranged at a side of the first beam direction regulator opposite to the illumination direction for reflecting incident light; and a transmittance/scattering switching device arranged at the illumination direction side of the light guide plate and capable of emitting incident light and switching between a state for transmitting and a state for scattering; wherein light from the light source emerges from the light guide plate in a direction opposite to the illumination direction, passes through the first beam direction regulator, and is reflected by the reflecting member; and the reflected light passes through the first beam direction regulator, the light guide plate, and the transmittance/scattering switching device and emerges in the illumination direction.

The first beam direction regulator may comprise a light absorption layer and a transparent layer; and the light absorption layer and the transparent layer may be alternately laminated.

An extension direction of the light absorption layer of the first beam direction regulator may be parallel or perpendicular to a light guiding direction in the light guide plate of incident light from the light source.

Also, an extension direction of the light absorption layer of the first beam direction regulator may be inclined with respect to a light guiding direction in the light guide plate of incident light from the light source or a direction perpendicular thereto.

Additionally, the first beam direction regulator may comprise a plurality of laminated beam direction regulators comprising a light absorption layer and a transparent layer; and extension directions of light absorption layers of the beam direction regulators may be mutually different.

Furthermore, the first beam direction regulator may have a light absorption layer and a transparent layer; and a cross-sectional shape of the transparent layer in a plane perpendicular to the irradiation direction may be any of a polygon, a circle, or an ellipse.

A configuration may comprise a second beam direction regulator between the light guide plate and the transmittance/scattering switching device.

Each of the first and the second beam direction regulators may comprise a beam direction regulator having an alternately laminated light absorption layer and transparent layer.

A configuration is possible wherein an extension direction of the light absorption layer of one of the first or the second beam direction regulator is parallel or inclined with respect to a light guiding direction in the light guide plate of incident light from the light source, and an extension direction of the light absorption layer of the other of the first or the second beam direction regulator is parallel or inclined with respect to a direction perpendicular to a light guiding direction in the light guide plate of incident light from the light source.

A configuration may comprise a third beam direction regulator proximal to a light incident face of the light guide plate wherein light enters from the light source.

A configuration is possible wherein the third beam direction regulator is a beam direction regulator wherein a light absorption layer and a transparent layer are alternately laminated, and the light absorption layer extends parallel to a thickness direction of the light guide plate.

A reflection face of the reflecting member may be inclined with respect to a plane of the first beam direction regulator opposing the reflection face.

The first beam direction regulator and the reflecting member may be combined.

A configuration may comprise a prism sheet or a spherical/aspherical lens sheet between the light guide plate and the transmittance/scattering switching device.

A configuration may comprise either or both of a light concentrator and a diffuser.

A method for illuminating according to the present invention may be characterized by: causing light from a light source to emerge from a light guide plate in a direction opposite to a predetermined illumination direction; receiving light from the light guide plate, regulating a direction of the light by a first beam direction regulator, and emitting the light; reflecting light from the first beam direction regulator by a reflecting member and transmitting the light through the first beam direction regulator and the light guide plate; and causing light emerging from the light guide plate to emerge from a transmittance/scattering switching device, and switching between a state for transmitting and a state for scattering light.

A display apparatus according to the present invention comprises the illumination apparatus and a display panel. Furthermore, the display panel may be, for example, a liquid crystal display panel.

### EFFECT OF THE INVENTION

According to the invention related to claim 1, transmittance/scattering is controlled by a transmittance/scattering switching device, thereby controlling an emerging light angular distribution from an illumination apparatus. Then, a first beam direction regulator is arranged behind a light guide plate with respect to an illumination direction, and therefore a large distance exists between a display panel such as a liquid crystal display panel arranged at a front of the light guide plate, i.e., illumination direction side of the illumination apparatus of the present invention, and a first beam direction regulator; and moiré effects due to an interference between the display panel and the first beam direction regulator can be suppressed. Furthermore, a large distance exists between the first beam direction regulator and a light emergence face of the transmittance/scattering switching device, and therefore light emerging from the first beam direction regulator widens and uneven luminance can be suppressed. Also, by reflecting light transmitted through the first beam direction regulator by a reflecting member and once again transmitting the light through the first beam direction regulator, even in the case where the thickness of the first beam direction regulator is half the thickness of a beam direction regulator of a conventional illumination apparatus, it is possible to produce a maximum light emergence angle from the first beam direction regulator identical to a maximum light emergence angle from the beam direction regulator of the conventional illumination apparatus. Thus, the emerging light angle can be controlled using half of the thickness of a conventional beam direction regulator, and therefore a thickness reduction of the illumination apparatus is possible.

Also, according to the invention related to claim 13, a reflecting member and a first beam direction regulator are combined, thereby improving the control precision of the emerging light angular distribution and improving the light utilization efficiency of the illumination apparatus.

Additionally, according to the invention related to claim 16, moiré effects and uneven luminance can be suppressed by comprising an illumination apparatus of the present invention; and a thin display apparatus capable of controlling a viewing angle can be provided.

### BRIEF DESCRIPTION OF DRAWINGS

FIG. 1 is a side view schematically illustrating an illumination apparatus according to a first exemplary embodiment of the present invention.

FIG. 2A is a top view schematically illustrating a beam direction regulator according to this exemplary embodiment, and FIG. 2B is a cross-sectional view thereof.

FIG. 3 is a top view schematically illustrating a light absorption of a beam direction regulator of the first exemplary embodiment.

FIG. 4 is a top view schematically illustrating another light absorption of a beam direction regulator of the first exemplary embodiment.

FIG. 5 is a side view schematically illustrating an illumination apparatus according to a second exemplary embodiment of the present invention.

FIG. 6 is a top view schematically illustrating a light absorption of a beam direction regulator of the second exemplary embodiment.

FIG. 7 is a side view schematically illustrating an illumination apparatus according to a third exemplary embodiment of the present invention.

FIG. 8A is a side view schematically illustrating a conventional illumination apparatus, and FIG. 8B is a side view schematically illustrating the illumination apparatus of this exemplary embodiment.

FIG. 9A is a cross-sectional view schematically illustrating a beam direction regulator and beam regulation directions of a conventional illumination apparatus, and FIG. 9B is a cross-sectional view schematically illustrating a beam direction regulator and beam regulation directions of the illumination apparatus of this exemplary embodiment.

FIG. 10 is a side view illustrating an operation of the illumination apparatus according to the first exemplary embodiment.

FIG. 11 is a cross-sectional view schematically illustrating a beam direction regulator having protective layers on surfaces.

FIG. 12 is a cross-sectional view schematically illustrating a path of light between a beam direction regulator and a reflection plate.

FIG. 13 is a side view schematically illustrating a prism face of a light guide plate.

FIG. 14 is a side view illustrating a path of emerging light from a light guide plate.

FIG. 15 is a side view schematically illustrating a modification of the first exemplary embodiment.

FIG. 16 is a side view schematically illustrating an illumination apparatus having a prism sheet arranged in the illumination direction.

FIG. 17 is a side view schematically illustrating emerging light from a light guide plate and a beam direction regulator.

FIG. 18 is a cross-sectional view schematically illustrating a beam direction regulator and beam regulation directions.

FIG. 19A is a cross-sectional view illustrating a reflection face of a reflection plate according to the first exemplary embodiment, and FIG. 19B is a cross-sectional view illustrating a reflection face of a reflection plate according to a fourth exemplary embodiment.

FIG. 20 is a cross-sectional view illustrating another reflection face of the reflection plate of the fourth exemplary embodiment.

FIG. 21A is a top view schematically illustrating an illumination apparatus according to the second exemplary embodiment of the present invention, and FIG. 21B is a cross-sectional view thereof.

FIG. 22 is a schematic drawing illustrating a modification of the third exemplary embodiment of the present invention, of which FIG. 22A is a side view and FIG. 22B is a cross-sectional view.

FIG. 23 schematically illustrates a configuration of Example 1, of which FIG. 23A is a top view and FIG. 23B is a cross-sectional view.

FIG. 24 is a graph illustrating an emerging light angular distribution of Example 1.

FIG. 25 is a side view schematically illustrating a configuration of Example 2, of which FIG. 25A illustrates a light guide plate, FIG. 25B illustrates a beam direction regulator, and FIG. 25C illustrates an illumination apparatus.

FIG. 26 is a graph illustrating an emerging light angular distribution of Example 2.

FIG. 27 is a side view schematically illustrating a configuration of Example 3.

FIG. 28 is a graph illustrating an emerging light angular distribution of Example 3.

FIG. 29 is a schematic drawing illustrating a beam direction regulator of Example 4 having a prism face.

FIG. 30 is a graph illustrating an emerging light angular distribution of Example 4.

FIG. 31 is a perspective view illustrating the conventional illumination apparatus according to Patent Literature 1.

### DESCRIPTION OF THE REFERENCE NUMERALS

1: Illumination apparatus

2: Light source

3: Light guide plate

4: Transmittance/scattering switching device

5, 15: Beam direction regulator

6: Reflection plate

7: Illumination direction

8: Light absorption layer

9: Transparent layer

10: Light guiding direction of light in the light guide plate

11: Second beam direction regulator

12: Light absorption layer of the first beam direction regulator

13: Light absorption layer of the second beam direction regulator

14: Third beam direction regulator

16: Liquid crystal display panel

17: Protective layer

18: Light emerging from the light guide plate toward the beam direction regulator

19: Prism sheet

20: Extension direction of the light absorption layer

21: Light absorption layer of the third beam direction regulator

22: Mixing region

### BEST MODE FOR CARRYING OUT THE INVENTION

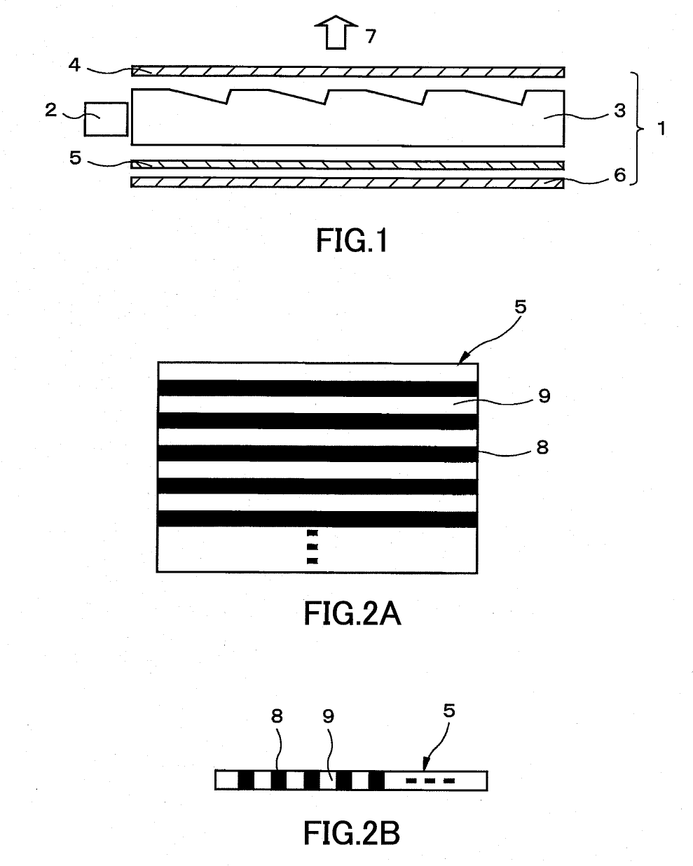

Hereinafter, exemplary embodiments of the present invention will be described in detail with reference to the attached drawings. First, an illumination apparatus according to a first exemplary embodiment of the present invention will be described. FIG. 1 is a side view schematically illustrating the illumination apparatus according to the first exemplary embodiment of the present invention.

As illustrated in FIG. 1, an illumination apparatus 1 of this exemplary embodiment comprises: a light source 2; a light guide plate 3; a beam direction regulator 5 for regulating a direction of incident light and emitting the light; a reflection plate 6; and a transmittance/scattering switching device 4, i.e., a device capable of switching the transmittance/scattering of light. The light source 2 is arranged on a side face of the light guide plate 3; and a plurality of inclined faces is formed on a face of the light guide plate 3 of an illumination direction 7 for causing light from the light source 2 to emerge in a direction opposite to the illumination direction 7. Also, the beam direction regulator 5 having a plurality of transparent layers separated by a plurality of light absorption layers is arranged at a side of the light guide plate 3 opposite to the illumination direction 7; and furthermore, the reflection plate 6 is arranged at a side of the beam direction regulator 5 opposite to the illumination direction 7. The reflection plate 6 has a reflection face for reflecting light and is arranged with the reflection face perpendicular to the illumination direction 7. The reflection plate 6 reflects light from the light guide plate 2 passing through the beam direction regulator 5 and emerging in a direction opposite to the illumination direction 7, and causes the reflected light to once again enter the beam direction regulator 5. Also, the transmittance/scattering switching device 4 capable of emitting incident light and switching between a transmitting state and a scattering state is arranged on the irradiation direction 7 side of the light guide plate 3. Light reflected at the reflection plate 6 passes through the beam direction regulator 5 and the light guide plate 3, enters the transmittance/scattering switching device 4, and then emerges in a transmitting or scattering state.

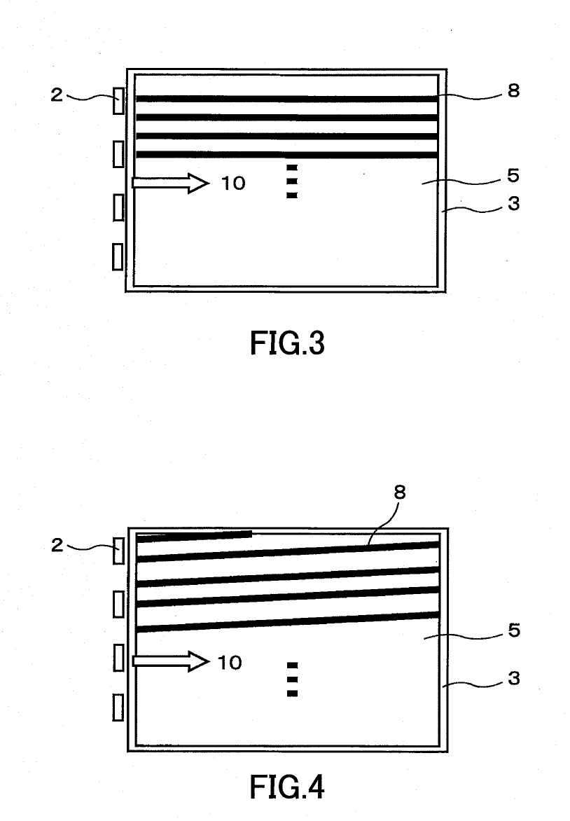

FIG. 2A is a top view schematically illustrating the beam direction regulator 5 according to this exemplary embodiment, and FIG. 2B is a cross-sectional view thereof. As illustrated in FIGS. 2A and B, a beam direction regulator 5 may be used wherein light absorption layers 8 and transparent layers 9 are alternately laminated, and the light absorption layers 8 and the transparent layers 9 extend mutually parallel in a direction perpendicular to the lamination direction thereof. As illustrated in FIG. 3, according to this exemplary embodiment, the beam direction regulator 5 is arranged such that the extension direction of the light absorption layers 8 and a light guiding direction 10 of the light in the light guide plate are mutually parallel. An emerging light angular distribution of a direction perpendicular to the light guiding direction 10 of the light in the light guide plate is regulated by such an arrangement.

According to the first exemplary embodiment, the beam direction regulator 5 is arranged such that the extension direction of the light absorption layers 8 is parallel to the light guiding direction 10 of the light in the light guide plate, but the beam direction regulator 5 also may be arranged such that the extension direction of the light absorption layers 8 and the light guiding direction 10 of the light in the light guide plate are perpendicular. In such a case, the angle regulation direction of the emerging light is orthogonal to that of this exemplary embodiment.

A transparent polymer material such as polyethylene, polypropylene, or polysilicon (silicone rubber), etc. may be used as the transparent layer 9 of the beam direction regulator 5; and the light absorption layer 8 may comprise a mixture such as carbon black or a pigment mixed into the polymer material. Then, the beam direction regulator 5 of this exemplary embodiment can be made by alternately laminating these transparent layers and light absorption layers. Also, the construction is possible by a method for using a die or the like to form a pattern for the transparent layer or the light absorption layer, after which the light absorption layer material or the transparent layer material is filled into a recessed portion. A beam direction regulator having a transparent layer with a planar shape of a polygon, a circle, or an ellipse also may be made similarly.

The reflection plate 6 of the illumination apparatus 1 of this exemplary embodiment may be formed, for example, of Al (aluminum) material. In FIG. 1, the beam direction regulator 5 and the reflection plate 6 are separated, but in the case where a gap 31 exists between the beam direction regulator 5 and the reflection plate 6 as illustrated in FIG. 12, light may pass through the adjacent transparent layer 9 and emerge in an illumination direction at an emergence angle larger than a maximum emerging light angle. Therefore, it is desirable that the beam direction regulator 5 and the reflection plate 6 are combined, and the beam direction regulator 5 and the reflection face of the reflection plate 6 contact each other. The combination of the beam direction regulator 5 and the reflection plate 6 may be realized by bonding the beam direction regulator 5 and the reflection plate 6, forming a reflective layer on one face of the beam direction regulator 5 such as by performing Al vapor deposition or sputtering, etc.

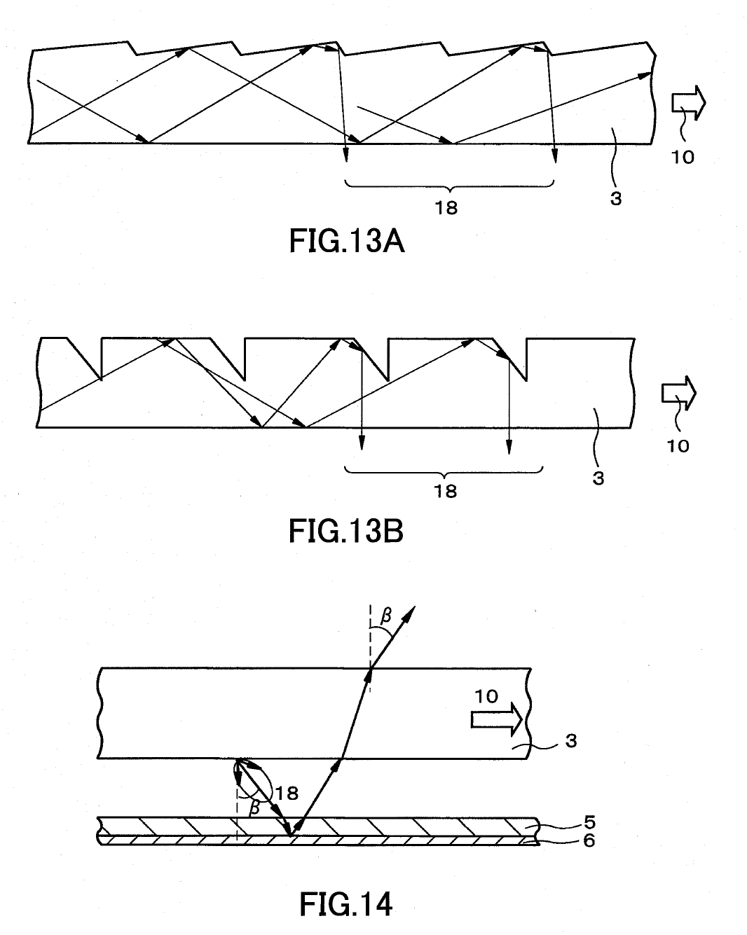

Next, the light guide plate 3 of the illumination apparatus 1 of this exemplary embodiment will be described. The light guide plate 3 may be made using, for example, a transparent material such as a resin (acrylic resin, etc.) or glass; and in the case of a resin, the construction is possible by a method such as injection molding, hot pressing, milling, etc. An existing light guide plate for a backlight/frontlight and the like used in portable/small terminals may be used as the light guide plate 3 of this exemplary embodiment, and one example thereof is illustrated in FIG. 13. FIG. 13 illustrates a configuration wherein a beam proceeding in the light guiding direction 10 of the light in the light guide plate is reflected by a prism face formed in an upper face of the light guide plate 3 and emerges from the light guide plate toward the beam direction regulator as an emerging light 18. FIG. 13A is an example wherein the prism face comprises a plurality of faces inclined with respect to the light guiding direction 10 of the light in the light guide plate, and FIG. 13B is an example wherein the prism face comprises a plurality of inclined faces formed in a portion of a planar face parallel to the light guiding direction 10 of the light in the light guide plate.

Also, a liquid crystal device capable of controlling a transmittance/scattering ability such as a polymer dispersed liquid crystal (PNLC) device and the like may be used as the transmittance/scattering switching device 4 of this exemplary embodiment. In particular, a PNLC device is favorable because the degree of the transmittance/scattering can be changed by an electrical potential applied between substrates. Additionally, it is possible to use a cold cathode fluorescent tube, an LED (Light Emitting Diode), or the like as the light source 2 of this exemplary embodiment.

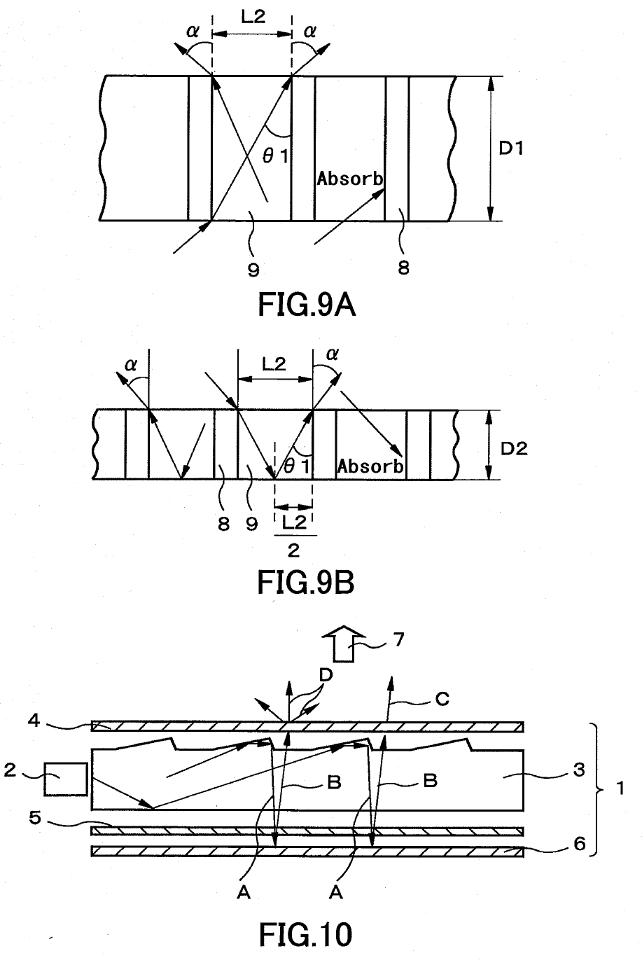

Next, an operation of this exemplary embodiment will be described using FIG. 10. Light emerging from the light source 2 of the illumination apparatus 1 of this exemplary embodiment enters the light guide plate 3 and is caused to emerge in a direction opposite to the illumination direction 7 by the light guide plate 3 (beam A). The light passes through the beam direction regulator 5, is reflected by the reflection plate 6, once again passes through the beam direction regulator 5 and the light guide plate 3, and emerges toward the illumination direction 7 (beam B). At this time, as illustrated in FIG. 9B, incident light from a direction at an angle greatly inclined with respect to a direction perpendicular to the light incident face of the beam direction regulator 8 is absorbed by the light absorption layer 8 arranged in the beam direction regulator 5. Therefore, the angular distribution of the light emerging from the beam direction regulator 5 is restricted, and light having a narrow emerging light angular distribution emerges. The light emerging from the beam direction regulator 5 passes through the light guide plate 3 and enters the transmittance/scattering switching device 4. At this time, in the case where the transmittance/scattering switching device 4 is in a transmitting state, the light entering the transmittance/scattering switching device 4 is transmitted unaltered by the transmittance/scattering switching device 4, and an illumination of a narrow emerging light angular distribution can be obtained (beam C). Also, in the case where the transmittance/scattering switching device 4 is in a scattering state, the light entering the transmittance/scattering switching device 4 is scattered by the transmittance/scattering switching device 4, and an illumination of a wide emerging light angular distribution can be obtained (beam D). The switching between the transmitting state and the scattering state of the transmittance/scattering switching device 4 may be performed by, for example, the existence or absence of an electrical potential applied to the transmittance/scattering switching device 4.

Referencing FIG. 8 and FIG. 9, the illumination apparatus of this exemplary embodiment and a conventional illumination apparatus will be compared, and the characteristics of the present invention will be described in further detail. FIG. 8A is a side view schematically illustrating a conventional illumination apparatus, and FIG. 8B is a side view schematically illustrating the illumination apparatus of this exemplary embodiment. Also, FIG. 9A is a cross-sectional view illustrating a beam direction regulator and beam regulation directions of the conventional illumination apparatus, and FIG. 9B is a cross-sectional view illustrating a beam direction regulator and beam regulation directions of the illumination apparatus of this exemplary embodiment.

As illustrated in FIG. 8A, the light source 2 is arranged at a side face of the light guide plate 3, and the beam direction regulator 5 is arranged at an upper face of the light guide plate 3 in the conventional illumination apparatus. Also, the transmittance/scattering switching device 4 is arranged above the beam direction regulator 5. Additionally, a liquid crystal display panel 16 is arranged above the conventional illumination apparatus. In a conventional illumination apparatus thus configured, a distance L1 between the liquid crystal display panel 16 and the beam direction regulator 5 is small, and therefore moiré effects occur due to interference between structural bodies (such as a black matrix or internal circuitry, etc.) in the liquid crystal display panel 16 and the beam direction regulator 5.

On the other hand, in FIG. 8B, the liquid crystal display panel 16 is arranged above the illumination apparatus 1 of this exemplary embodiment. According to this exemplary embodiment, the light guide plate 3 exists between the liquid crystal display panel 16 and the beam direction regulator 5, and therefore the distance L1 between the liquid crystal display panel 16 and the beam direction regulator 5 widens, and moiré effects can be suppressed.

Also, for the conventional illumination apparatus, in the case where light from a backlight or a light source is used for the display, a thickness D1 of the beam direction regulator 5 is determined as follows. As illustrated in FIG. 9A, setting a width of the transparent layer 9 of the cross section of the beam direction regulator 5 (refractive index: n₁) to L2, and setting a maximum emerging light angle of light emerging from the beam direction regulator 5 to a (emergence angular distribution width M1=2×a), an angle θ₁ between a straight line connecting opposite angles of the transparent layer 8, i.e., the path of the beam, and an interface of the light absorption layer 8 and the transparent layer 9 satisfies formula 1 recited below according to Snell's law.

$${θ}_{1} = {sin}^{- 1} ( \frac{1}{{n}_{1}} sin ( α ) ) \qquad [ Formula 1 ]$$

Here, the angle a is an inclination angle from a direction perpendicular to the upper face or the lower face of the beam direction regulator 5. The thickness D1 of the beam direction regulator 5 is determined by formula 2 recited below from a geometric relation to the angle θ₁.

$$D 1 = \frac{L 2}{tan ( {θ}_{1} )} \qquad [ Formula 2 ]$$

Conversely, a thickness D2 of the beam direction regulator 5 according to this exemplary embodiment is determined as follows. As illustrated in FIG. 9B, an incident beam from the upper face of the beam direction regulator 5 passes downward through the transparent layer 9 of the beam direction regulator 5; is then reflected by a reflection plate (not illustrated in FIG. 9B) arranged at the lower face of the beam direction regulator 5; then once again passes through the beam direction regulator 5; and then emerges from the upper face of the beam direction regulator 5. Setting the maximum emerging light angle of the light emerging from the beam direction regulator 5 to a, the angle θ₁ determined by formula 1 recited above differs from that of FIG. 9A; is determined from a right triangle having two sides consisting of half of the width L2/2 of the transparent layer 9 and the thickness D2 of the beam direction regulator 5 as illustrated in FIG. 9B; and satisfies formula 3 recited below.

$$D 2 = \frac{L 2}{2 \times tan ( {θ}_{1} )} \qquad [ Formula 3 ]$$

It is obvious from formulae 2 and 3 that for the same maximum emergence angle a, the thickness D2 of the beam direction regulator of this exemplary embodiment is half of the thickness D1 of the conventional beam direction regulator. Thus, the beam regulator of this exemplary embodiment can realize the same maximum emergence angle with half the thickness of the beam direction regulator used in the conventional illumination apparatus, and therefore a thickness reduction of the entire illumination apparatus is possible.

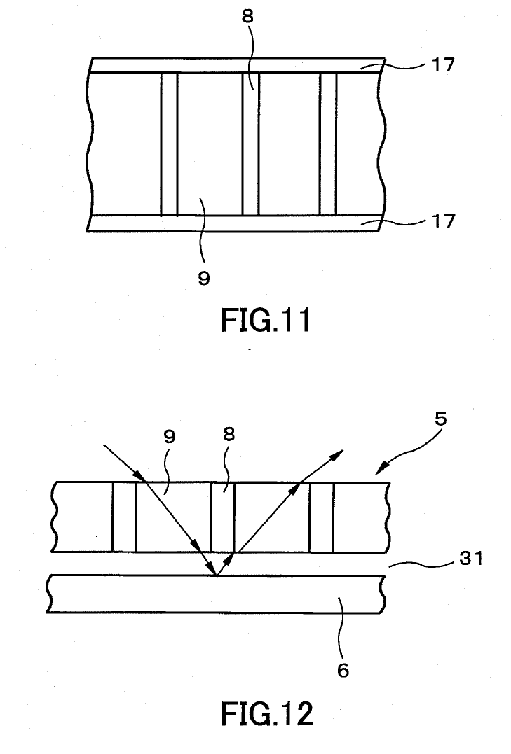

A protective layer 17 may be arranged on the beam direction regulator 5 as illustrated in FIG. 11. In FIG. 11, the protective layer 17 is arranged on each of the upper and lower faces of the beam direction regulator 5 comprising the alternately arranged transparent layers 9 and light absorption layers 8. Films such as polycarbonate, polyethylene terephthalate, and the like may be used as the protective layer 17, and the protective layer may be formed by adhering such films to a light control film by a bonding agent. In such a configuration, and in the case where the refractive indices of the beam direction regulator 5 and the protective layer 17 are different, the structure of the beam direction regulator may be determined by considering the refractive index of the protective layer 17 and changing formula 3.

Also, for some existing light guide plates, a maximum luminance direction (emerging light angular distribution) of the emerging light 18 from the light guide plate toward the beam direction regulator is inclined (inclination angle β) with respect to a direction perpendicular to the light guiding direction 10 of the light in the light guide plate as illustrated in FIG. 14. In an illumination apparatus combining a light guide plate 3 and a beam direction regulator 5 wherein the light absorption layers extend parallel to the light guiding direction of the light guide plate 3 (restricting the emerging light angular distribution in the direction perpendicular to the light guiding direction), the beam regulation direction and the light guiding direction are orthogonal; and therefore effects on the emerging light angular distribution control by such inclinations of emerging light are minor, although the emerging light from the illumination apparatus also emerges at an inclination of angle β.

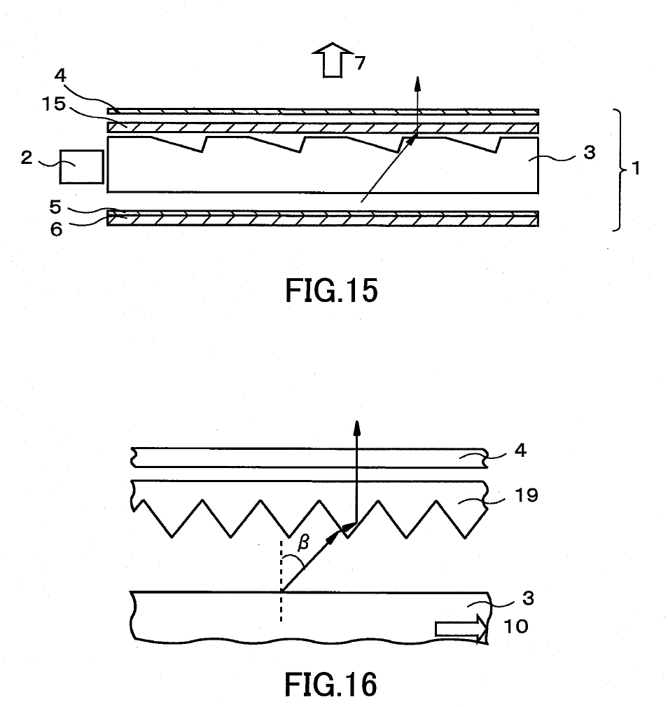

In such a case, emerging light in a direction perpendicular to the light guiding direction of the light guide plate can be obtained by arranging a new beam direction regulator between the light guide plate and the transmittance/scattering switching device. FIG. 15 is a side view schematically illustrating a modification of the first exemplary embodiment; and as illustrated in FIG. 15, emerging light can be obtained in a direction perpendicular to the light guiding direction of the light guide plate 3 by arranging a beam direction regulator 15 in addition to the beam direction regulator 5 between the light guide plate 3 and the transmittance/scattering switching device 4. A prism sheet 19 such as that illustrated in FIG. 16, a spherical/aspherical lens sheet, or the like may be used as such a beam direction regulator 15. In FIG. 16, the prism sheet 19 is arranged above the light guide plate 3; and light from the light guide plate 3 entering the prism sheet 19 at the inclination angle β undergoes a total internal reflection by an inclined face formed in the prism sheet 19 and emerges in a direction perpendicular to the plane of the transmittance/scattering switching device 4.

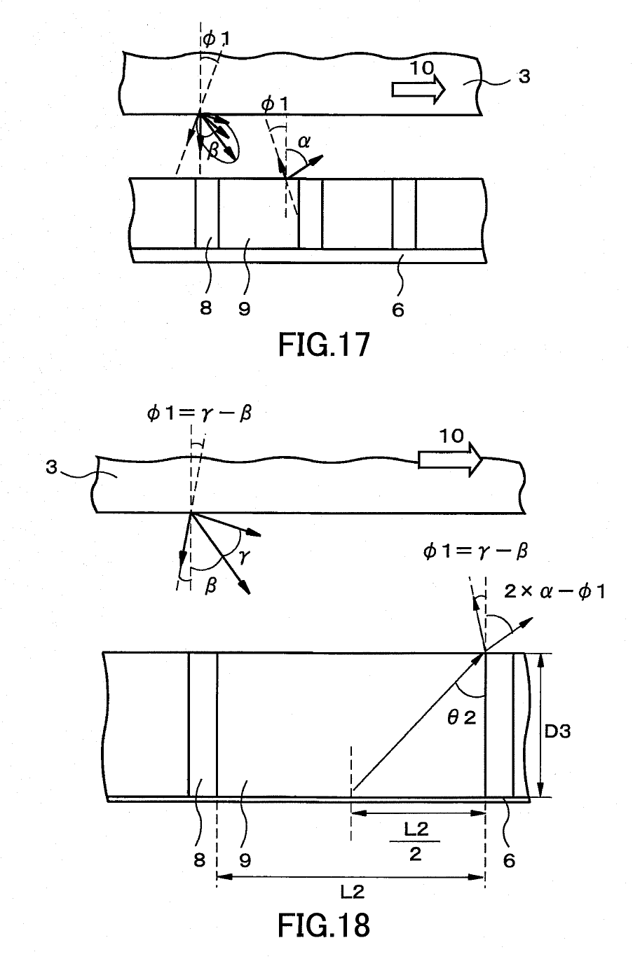

Also, in an illumination apparatus combining a light guide plate 3 and a beam direction regulator 5 wherein the light absorption layers extend in a direction perpendicular to the light guiding direction of the light guide plate 3 (restricting the emerging light angular distribution in a direction parallel to the light guiding direction) as in FIG. 14, emerging light from the light guide plate toward the beam direction regulator has a maximum luminance direction of the angle β direction, and the emerging light angular distribution is ±(β+f₁) as illustrated in FIG. 17. Therefore, the angular distribution of the light from the light guide plate 3 entering the beam direction regulator 5 is biased; and therefore in the case where a beam direction regulator having a thickness determined by formula 3 and FIG. 9B recited above is used, it is not possible to obtain the set emerging light angular distribution (angle range: ±a). Therefore, to obtain an emerging light angular distribution of ±a (emerging light angular distribution width M1=2×a), setting the angular distribution of the light from the light guide plate 3 entering the beam direction regulator 5 to a range of ±y (emerging light angular distribution width M2=2×y), a thickness D3 of the beam direction regulator may be determined considering the inclination angle β to satisfy formulae 4 to 6 recited below as illustrated in FIG. 18.

$$\begin{matrix}{ϕ}_{1} = γ - β & [ Formula 4 ] \\ {θ}_{2} = {sin}^{- 1} ( \frac{1}{{n}_{1}} sin ( 2 \times α - {ϕ}_{1} ) ) & [ Formula 5 ] \\ D 3 = \frac{L 2}{2 \times tan ( {θ}_{2} )} & [ Formula 6 ]\end{matrix}$$

Moreover, similar to the beam direction regulator wherein the light absorption layers extend parallel to the light guiding direction of the light in the light guide plate, emerging light in a direction perpendicular to the light guiding direction of the light in the light guide plate can be obtained by arranging the beam direction regulator 15 in the illumination direction 7 (referring to FIG. 15).

Next, effects of this exemplary embodiment will be described. In an illumination apparatus 1 of this exemplary embodiment, an emerging light angular distribution from the illumination apparatus 1 can be controlled by a control of transmittance/scattering by the transmittance/scattering switching device 4. Furthermore, the beam direction regulator 5 is behind the light guide plate 3 with respect to the illumination direction 7, and therefore distances to a liquid crystal display panel, a cover for illumination having a lens sheet and structural bodies (lenses, slits, etc.), and the like arranged in the illumination direction 7 increases; and moiré effects due to interference between these and the beam direction regulator 5 can be suppressed. Moreover, according to this exemplary embodiment, a thickness reduction of the illumination apparatus is possible. Also, the distance increases between the beam direction regulator 5 and the emergence face of the transmittance/scattering switching device 4, i.e., the final emergence face, and therefore the light emerging from the beam direction regulator 5 widens, and uneven luminance can be suppressed. Additionally, consolidating the reflection plate 6 and the beam direction regulator 5 improves the precision of the emerging light angular distribution control and also improves the light utilization efficiency of the illumination apparatus.

As illustrated in FIG. 4, the extension direction of the light absorption layer 8 may be inclined with respect to the light guiding direction 10 of the light in the light guide plate. Thus, moiré effects can be further suppressed in the case where the illumination apparatus and the liquid crystal display panel, etc. are combined.

Also, a beam direction regulator wherein a plurality of laminated beam direction regulators having mutually different directions of extension of the light absorption layers 8 can be used as the beam direction regulator 5. Furthermore, a beam direction regulator 5 may be used wherein a cross-sectional shape in a plane parallel to the light emergence face of the transparent layer of the beam direction regulator is any of a polygon, a circle, or an ellipse. Viewing angle control can be performed from multiple directions by using such a beam direction regulator 5.

The illumination apparatus of this exemplary embodiment may comprise either or both of a light concentrator and a diffuser, thereby enabling an adjustment of the emerging light angular distribution, uniformity, etc.

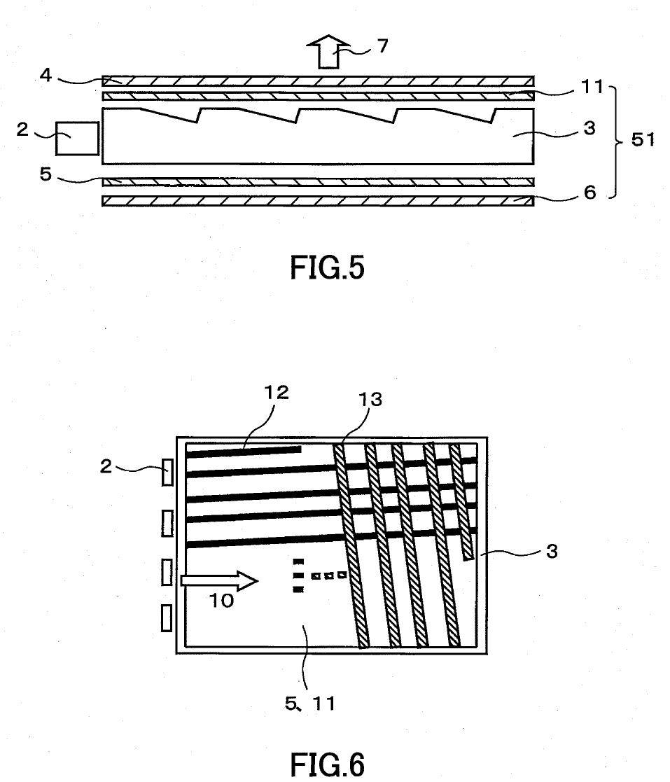

Next, an illumination apparatus according to a second exemplary embodiment of the present invention will be described. FIG. 5 is a side view schematically illustrating the illumination apparatus according to the second exemplary embodiment of the present invention. As illustrated in FIG. 5, a second beam direction regulator 11 is arranged between the light guide plate 3 and the transmittance/scattering switching device 4 in an illumination apparatus 51 of this exemplary embodiment. Thus, this exemplary embodiment has the second beam direction regulator 11 arranged between the light guide plate 3 and the transmittance/scattering switching device 4 in addition to the beam direction regulator 5 arranged at a side of the light guide plate 3 opposite to the illumination direction 7; and a beam direction regulator wherein a light absorption layer and a transparent layer are alternately laminated as illustrated in FIG. 2 may be used as such a beam direction regulator.

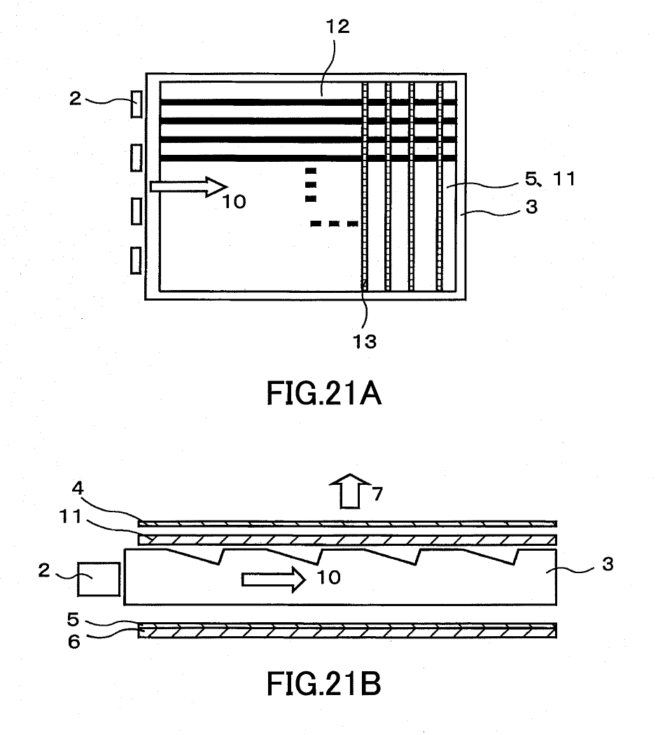

According to this exemplary embodiment, an angular distribution of light emerging from the light guide plate 3 in the illumination direction 7 can be regulated by the second beam direction regulator 11. In other words, a viewing angle control can be performed from multiple directions by changing the extension directions of the light absorption layers of the first beam direction regulator 5 and the second beam direction regulator 11 with respect to each other. For example, as illustrated in FIG. 6, the first beam direction regulator 5 may be arranged such that the extension direction of a light absorption layer 12 of the first beam direction regulator is inclined with respect to the light guiding direction 10 of the light in the light guide plate; and the second beam direction regulator 11 may be arranged such that the extension direction of a light absorption layer 13 of the second beam direction regulator and the extension direction of the light absorption layer 12 of the first beam direction regulator are orthogonal. Also, the extension direction of the light absorption layer 12 of the first beam direction regulator may be parallel or perpendicular to the light guiding direction 10 of the light in the light guide plate; and the angle between the extension direction of the light absorption layer 13 of the second beam direction regulator and the extension direction of the light absorption layer 12 of the first beam direction regulator may be any angle other than 0. FIG. 21A illustrates an example wherein the extension direction of the light absorption layer 12 of the first beam direction regulator is parallel to the light guiding direction 10 of the light in the light guide plate, and the extension direction of the light absorption layer 13 of the second beam direction regulator and the extension direction of the light absorption layer 12 of the first beam direction regulator are orthogonal. Furthermore, FIG. 21B is a side view of this exemplary embodiment corresponding to FIG. 21A and is essentially the same drawing as FIG. 5 (although the beam direction regulator 5 and the reflection plate 6 are combined in FIG. 21B). Other configurations, operations, and effects of this exemplary embodiment are similar to those of the first exemplary embodiment, and therefore a detailed description thereof is omitted.

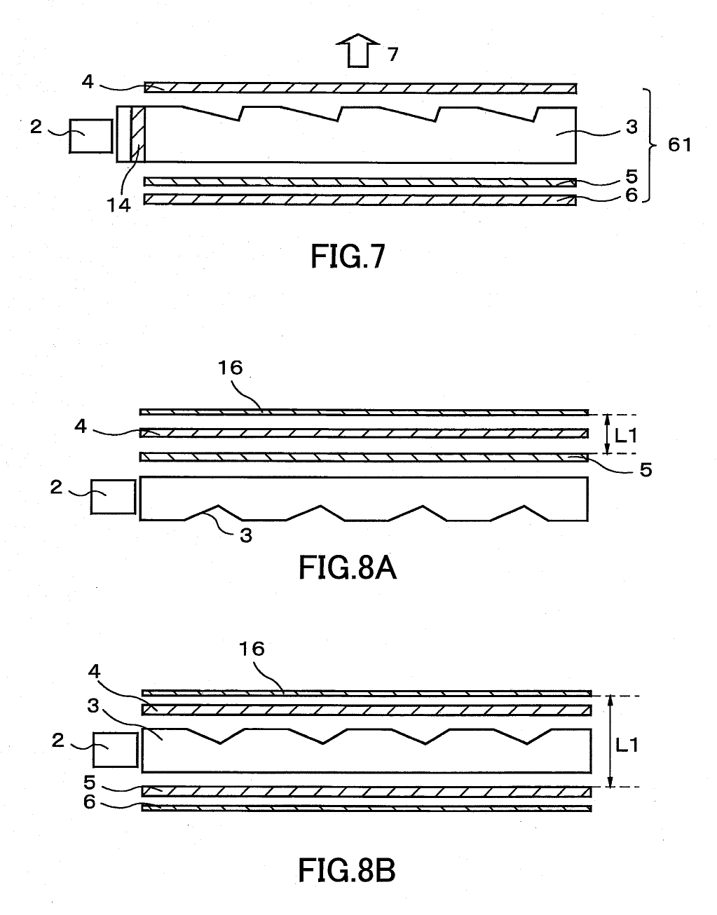

Next, an illumination apparatus according to a third exemplary embodiment of the present invention will be described. FIG. 7 is a side view schematically illustrating the illumination apparatus according to the third exemplary embodiment of the present invention. In an illumination apparatus 61 of this exemplary embodiment as illustrated in FIG. 7, in addition to the configuration of the first exemplary embodiment, a third beam direction regulator 14 is arranged proximally to a light incident face of the light guide plate 3 wherein light from the light source 2 enters. A beam direction regulator wherein a light absorption layer and a transparent layer are alternately laminated and the light absorption layer thereof extends mutually parallel to the thickness direction of the light guide plate may be used as the third beam direction regulator 14. By such a configuration, the angular distribution of light emerging from the light source 2 and entering the light guide plate 3 is regulated in a direction perpendicular to the extension direction of the light absorption layers, and the orientation of the light entering the light guide plate can be improved.

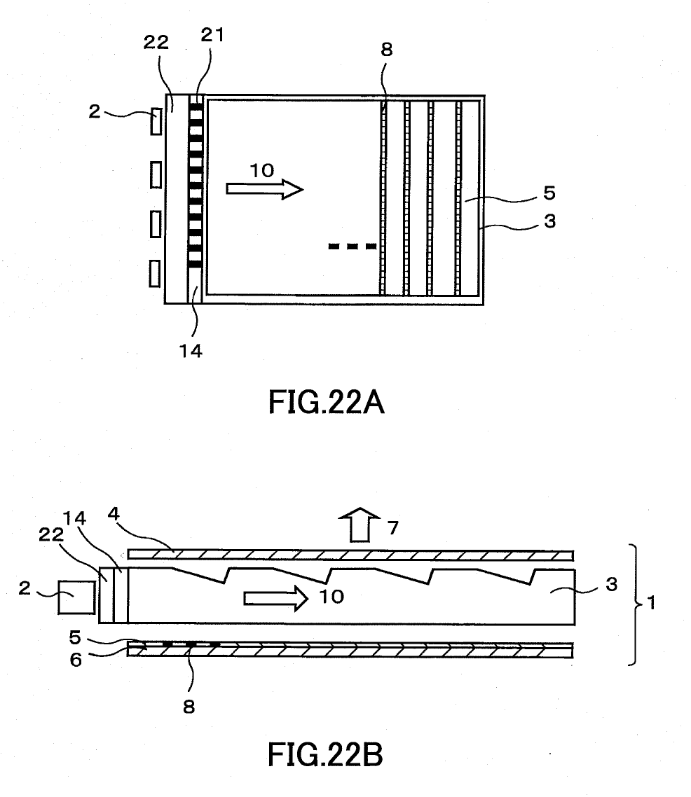

Also, FIG. 22 is a schematic drawing illustrating a modification of the third exemplary embodiment of the present invention; FIG. 22A is a side view; and FIG. 22B is a cross-sectional view. As illustrated in FIGS. 22A and B, the third beam direction regulator 14 is arranged proximally to the light incident face of the light guide plate 3 wherein light from the light source 2 enters; and a beam direction regulator 5 combined with the reflection plate 6 is arranged at a side of the light guide plate 3 opposite to the illumination direction 7. The extension direction of the light absorption layer 8 of the beam direction regulator 5 is perpendicular to the light guiding direction 10 of the light in the light guide plate. In addition to such a configuration, according to this exemplary embodiment, a mixing region 22 for mixing light from the light source 2 is arranged between the light incident face of the light guide plate 3 and the third beam direction regulator 14. Thus, in the case where the third beam direction regulator 14 is arranged proximally to the light incident face of the light guide plate 3 and a point light source such as an LED is used as the light source 2, a more uniform emerging light can be obtained by arranging the mixing region 22 as illustrated in FIG. 22. Other configurations, operations, and effects of this exemplary embodiment are similar to those of the first exemplary embodiment, and therefore a detailed description thereof is omitted.

Next, an illumination apparatus according to a fourth exemplary embodiment of the present invention will be described. The illumination apparatus of this exemplary embodiment is characterized in that a portion or the entirety of the reflection face of the reflection plate is inclined with respect to the plane of the beam direction regulator arranged opposite to the reflection plate. In other words, the reflection plate according to this exemplary embodiment has a reflection face inclined between the light absorption layers of the beam direction regulator or a reflection face inclined along the light absorption layers.

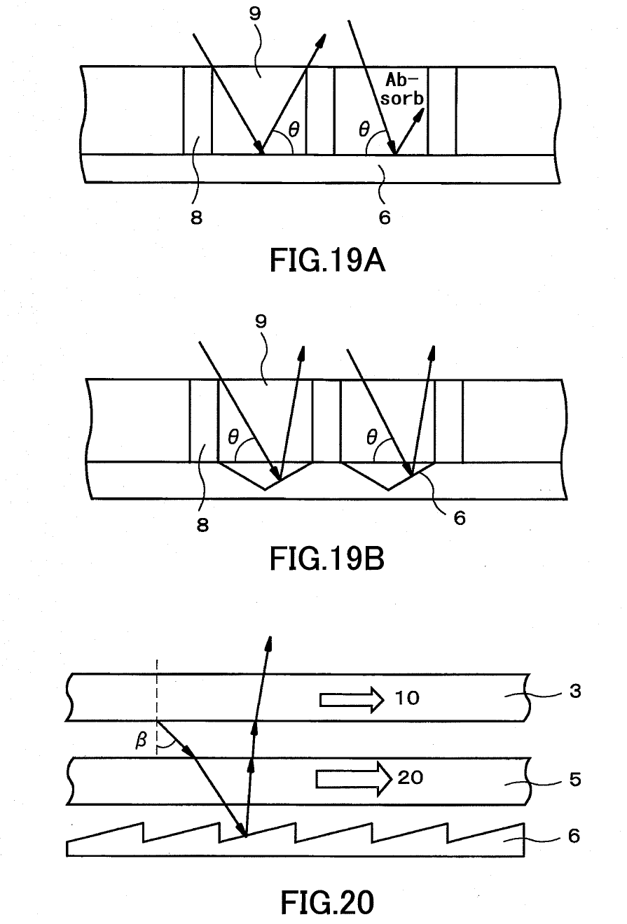

For example, in the case of a beam direction regulator wherein the extension direction of the light absorption layer is parallel to the light guiding direction of the light in the light guide plate, a reflection plate 6 having centrally symmetric inclined faces between the light absorption layers 8 may be used as illustrated in FIG. 19B. Using such a reflection plate 6 having an inclined face enables the emergence of light that would be lost due to absorption by a light absorption layer in the case where a flat reflection plate 6 is used (FIG. 19A), and the light utilization efficiency improves.

Also, as illustrated in FIG. 20, an emerging light angle can be adjusted as well by forming an inclined face along the light absorption layer (in other words, along a light absorption layer extension direction 20) on the reflection face of the reflection plate 6. Additionally, similar effects can be obtained for a beam direction regulator wherein the extension direction of the light absorption layer is perpendicular to the light guiding direction of the light in the light guide plate. Other configurations, operations, and effects of this exemplary embodiment are similar to those of the first exemplary embodiment, and therefore a detailed description thereof is omitted.

Next, a display apparatus according to a fifth exemplary embodiment of the present invention will be described. The display apparatus of this exemplary embodiment is a display apparatus comprising an illumination apparatus according to the present invention recited above. Such a display apparatus comprises, for example, a liquid crystal display apparatus having an illumination apparatus of the present invention and a liquid crystal display panel. Such a liquid crystal display apparatus is capable of viewing angle control, enables the suppression of moiré effects/uneven luminance, and also enables the realization of a thin display apparatus.

### EXAMPLES

Hereinafter, examples of the present invention will be described in comparison to a comparison example outside of the range of the present invention.

### Comparison Example 1

As a conventional beam direction regulator, a beam direction regulator having a transparent layer width L2=0.085 mm, a transparent layer refractive index n=1.60, a light absorption layer width L3=0.015 mm, and a thickness D1=0.258 mm was made and combined with a backlight and a PNLC device to make a conventional illumination apparatus (referring to FIG. 8A and FIG. 9A). As a result, a distribution having a maximum emerging light angle of 29.5° (emerging light angular distribution width M2=59°) in the emerging light angular control direction was obtained for a transmitting state of the PNLC.

### Example 1

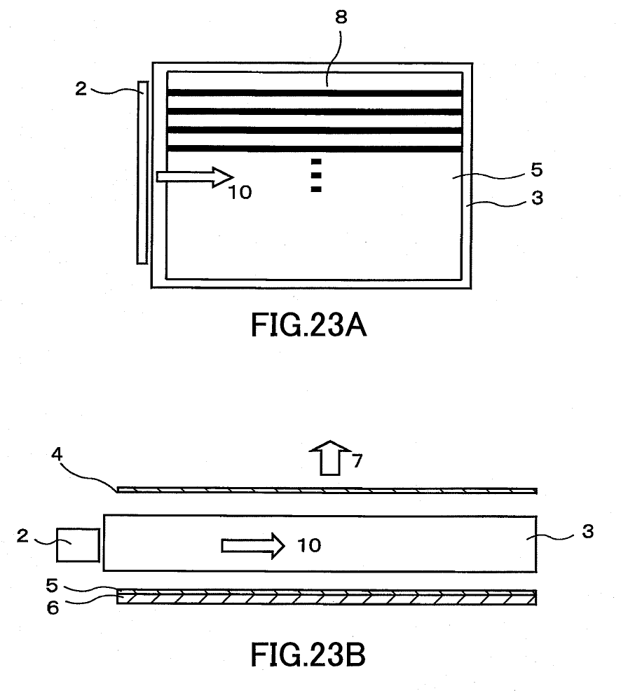

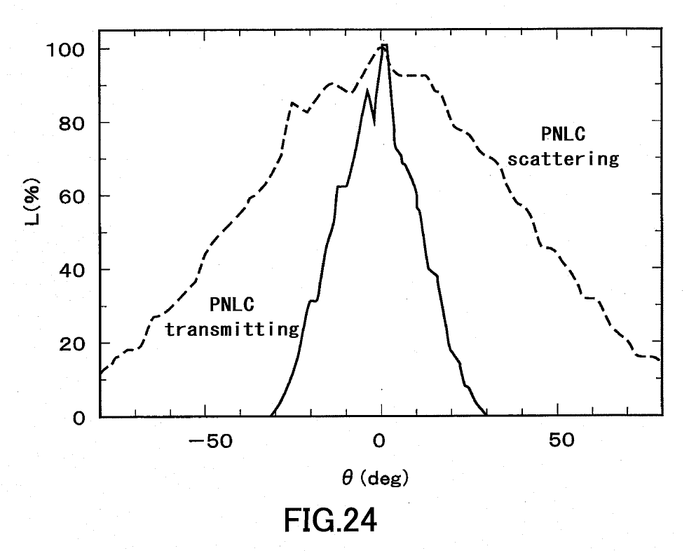

A beam direction regulator having a transparent layer width L2=0.085 mm, a transparent layer refractive index n=1.60, a light absorption layer width L3=0.015 mm, and a thickness D2=0.129 mm wherein an Al reflection plate was vapor-deposited on one face and the light absorption layers extended parallel to the light guiding direction of the light guide plate was made. The beam direction regulator, a line light source, a light guide plate, and a PNLC device were combined to make an illumination apparatus of the present invention as illustrated in FIG. 23. In FIG. 23, components identical to those of FIG. 1 and FIG. 3 are given identical reference numerals, and a detailed description thereof is omitted. As a result, as illustrated in FIG. 24, a distribution having a maximum emerging light angle of 31°0 (emerging light angular distribution width M2=62°) in the emerging light angular control direction (direction perpendicular to the light guiding direction) was obtained for a transmitting state of the PNLC; and it was shown that the emerging light angular distribution can be controlled similarly to a conventional beam direction regulator using a thin beam direction regulator half the thickness of the conventional beam direction regulator. FIG. 24 illustrates angular distributions of emerging light for each of a transmitting state and a scattering state of a PNLC; the horizontal axis represents the light emergence angle θ (deg.) and the vertical axis represents the relative luminance L (%).

### Example 2

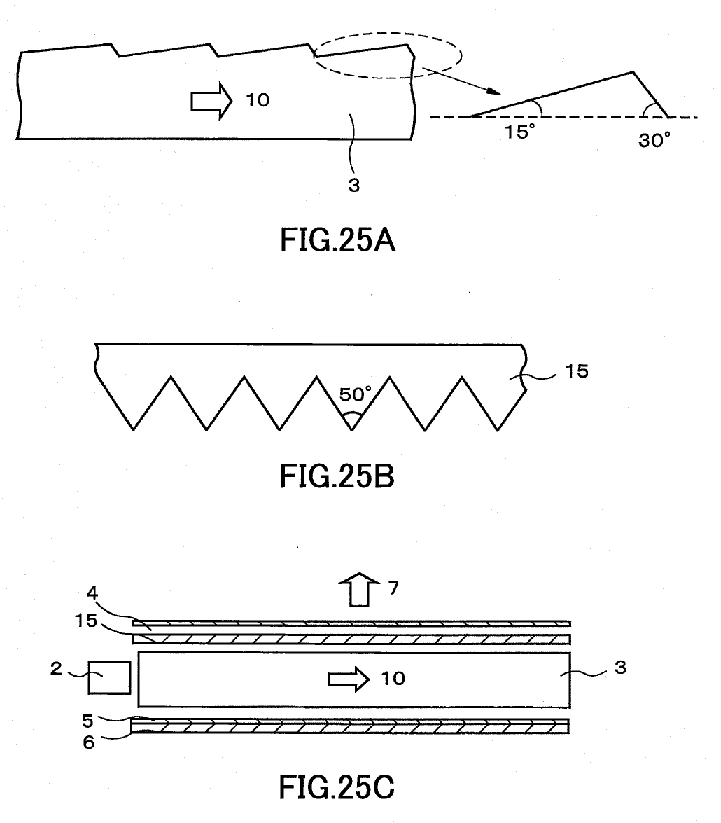

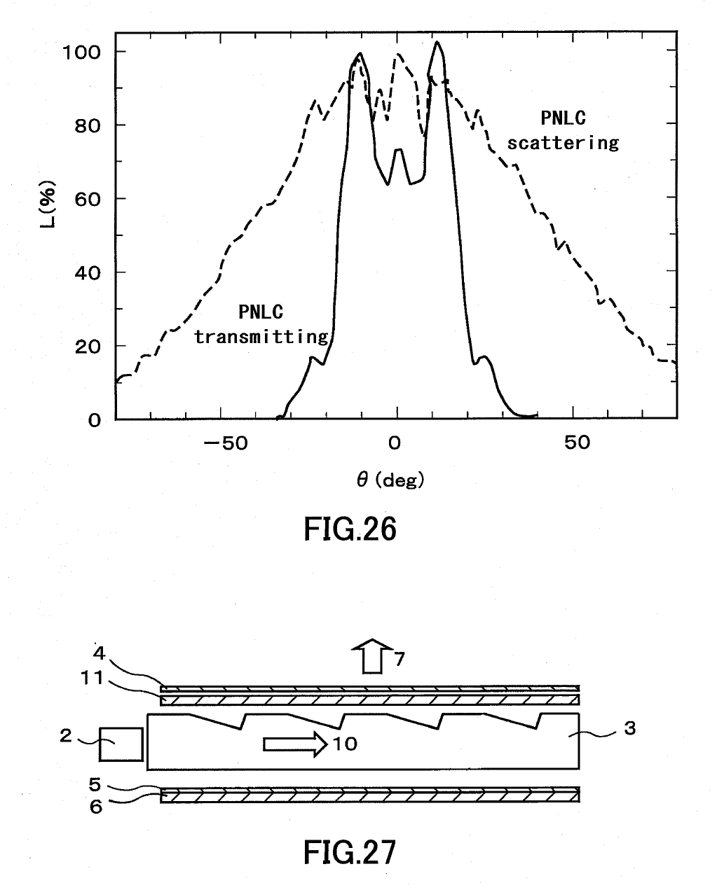

The beam direction regulator of example 1, a light guide plate as illustrated in FIG. 25A (emerging light inclination in the light guiding direction: β=about 43°), a beam direction regulator having a prism face with an apical angle of 50° (FIG. 25B), a line light source, and a PNLC device were combined to make an illumination apparatus of the present invention (FIG. 25C). FIG. 25C is a configuration similar to the modification of the first exemplary embodiment illustrated in FIG. 15. As a result, a distribution having a maximum emerging light angle of 31.5° (emerging light angular distribution width M2=63°) in the emerging light angular control direction (direction perpendicular to the light guiding direction) was obtained for a transmitting state of the PNLC as illustrated in FIG. 26. Furthermore, upon attaching a liquid crystal display panel to the illumination apparatus of this example, no moiré effects/uneven luminance were visually confirmed.

### Example 3

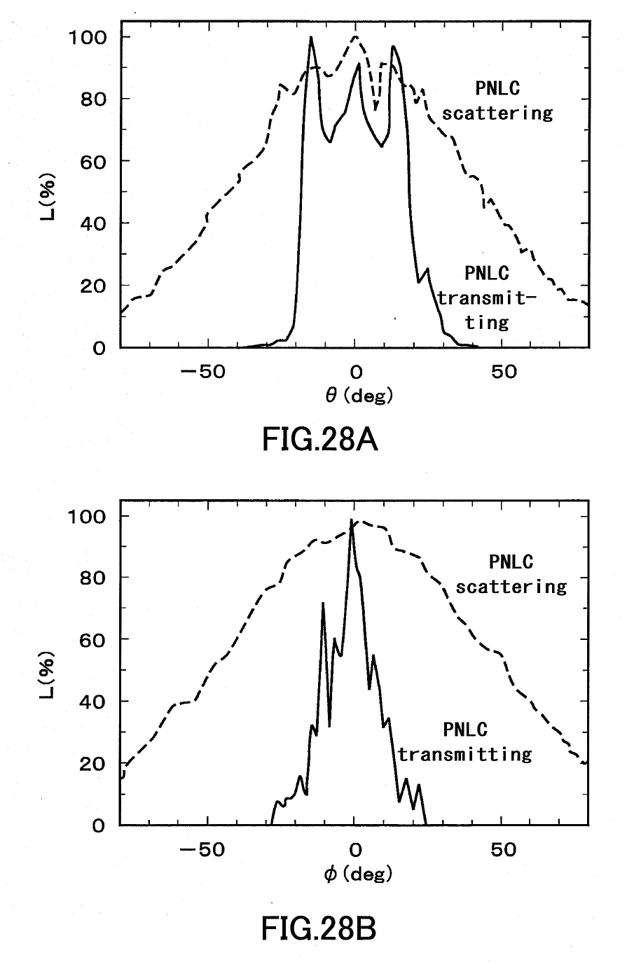

The beam direction regulator of comparison example 1 (second beam direction regulator) was arranged between the beam direction regulator and the PNLC device of the illumination apparatus of example 2 such that the light absorption layers extended perpendicular to the light guiding direction of the light guide plate to make an illumination apparatus (FIG. 27). As a result, a distribution having a maximum emerging light angle of 29° (−29° to +29°) in the direction perpendicular to the light guiding direction (FIG. 28A), and a distribution having a maximum emerging light angle of 29° (−29° to +23°) in the parallel direction (FIG. 28B) were obtained for a transmitting state of the PNLC as illustrated in FIG. 28. The configuration illustrated in FIG. 27 is identical to the configuration of the second exemplary embodiment illustrated in FIG. 21B.

### Example 4

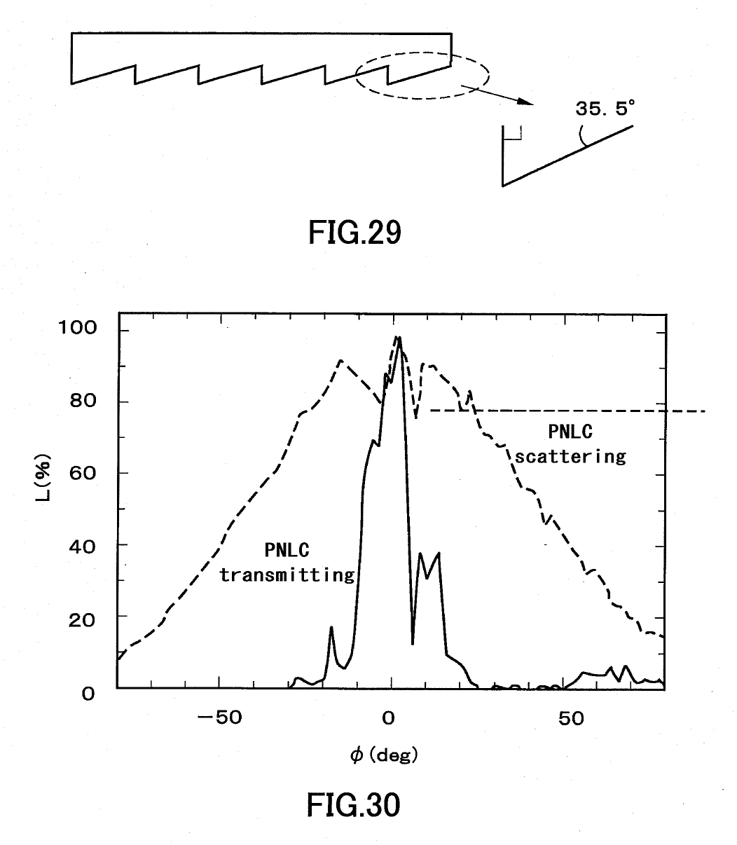

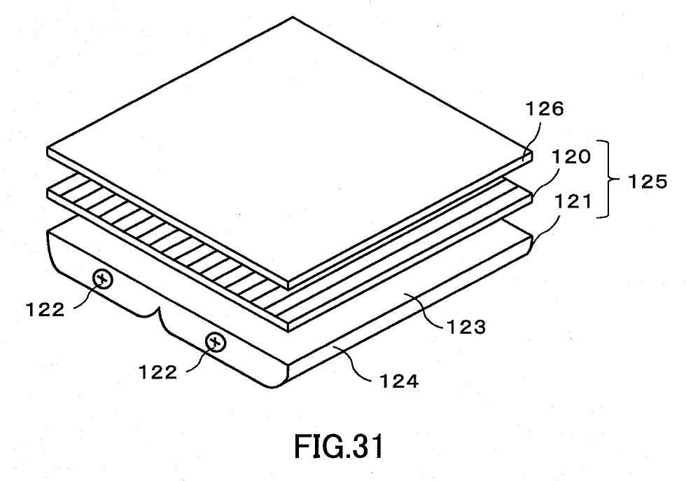

A beam direction regulator having a transparent layer width L2=0.085 mm, a transparent layer refractive index n=1.60, a light absorption layer width L3=0.015 mm, and a thickness D2=0.066 mm wherein an Al reflection plate was vapor-deposited on one face and the light absorption layers extended perpendicular to the light guiding direction of the light guide plate was made. This beam direction regulator; the line light source, the light guide plate, and the PNLC device of example 2; and a beam direction regulator having a prism face as illustrated in FIG. 29 were combined to make an illumination apparatus of the present invention. As a result, a maximum emerging light angle of 32° (−32° to +25°) in a direction parallel to the light guiding direction was obtained for a transmitting state of the PNLC as illustrated in FIG. 30.

### INDUSTRIAL APPLICABILITY

The present invention can be favorably used as an illumination (backlight) of a liquid crystal display apparatus, as interior lighting, etc.

1. An illumination apparatus comprising:
a light source;
a light guide plate for emitting incident light from the light source in a direction opposite to an illumination direction;
a first beam direction regulator arranged at a side of the light guide plate opposite to the illumination direction for regulating a direction of incident light and emitting the light;
a reflecting member arranged at a side of the first beam direction regulator opposite to the illumination direction for reflecting incident light; and
a transmittance/scattering switching device arranged at the illumination direction side of the light guide plate and capable of emitting incident light and switching between a state for transmitting and a state for scattering; wherein
light from the light source emerges from the light guide plate in a direction opposite to the illumination direction, passes through the first beam direction regulator, and is reflected by the reflecting member; and
the reflected light passes through the first beam direction regulator, the light guide plate, and the transmittance/scattering switching device and emerges in the illumination direction.

2. The illumination apparatus according to claim 1, wherein emerging light from the light guide plate is caused by the reflecting member to pass twice through the beam direction regulator and emerge in the illumination direction.

3. The illumination apparatus according to claim 1, wherein
the first beam direction regulator comprises a light absorption layer and a transparent layer, and
the light absorption layer and the transparent layer are alternately laminated.

4. The illumination apparatus according to claim 3, wherein an extension direction of the light absorption layer of the first beam direction regulator is parallel or perpendicular to a light guiding direction in the light guide plate of incident light from the light source.

5. The illumination apparatus according to claim 3, wherein an extension direction of the light absorption layer of the first beam direction regulator is inclined with respect to a light guiding direction in the light guide plate of incident light from the light source or a direction perpendicular thereto.

6. The illumination apparatus according to claim 1, wherein
the first beam direction regulator comprises a plurality of laminated beam direction regulators comprising a light absorption layer and a transparent layer, and
extension directions of light absorption layers of the beam direction regulators are mutually different.

7. The illumination apparatus according to claim 1, wherein
the first beam direction regulator comprises a light absorption layer and a transparent layer, and
a cross-sectional shape of the transparent layer in a plane perpendicular to the irradiation direction is any of a polygon, a circle, or an ellipse.

8. The illumination apparatus according to claim 1, comprising a second beam direction regulator between the light guide plate and the transmittance/scattering switching device.

9. The illumination apparatus according to claim 8, wherein each of the first and the second beam direction regulators is a beam direction regulator having an alternately laminated light absorption layer and transparent layer.

10. The illumination apparatus according to claim 9, wherein
an extension direction of the light absorption layer of one of the first or the second beam direction regulator is parallel or inclined with respect to a light guiding direction in the light guide plate of incident light from the light source, and
an extension direction of the light absorption layer of the other of the first or the second beam direction regulator is parallel or inclined with respect to a direction perpendicular to a light guiding direction in the light guide plate of incident light from the light source.

11. The illumination apparatus according to claim 1, comprising a third beam direction regulator proximal to a light incident face of the light guide plate of light entering the light guide plate from the light source.

12. The illumination apparatus according to claim 11, wherein
the third beam direction regulator is a beam direction regulator wherein a light absorption layer and a transparent layer are alternately laminated, and
the light absorption layer extends parallel to a thickness direction of the light guide plate.

13. The illumination apparatus according to claim 1, wherein a reflection face of the reflecting member is inclined with respect to a plane of the first beam direction regulator opposing the reflection face.

14. The illumination apparatus according to claim 1, wherein the first beam direction regulator and the reflecting member are combined.

15. The illumination apparatus according to claim 1, comprising a prism sheet or a spherical/aspherical lens sheet between the light guide plate and the transmittance/scattering switching device.

16. The illumination apparatus according to claim 1, comprising either or both of a light concentrator and a diffuser.

17. A method for illuminating characterized by:
causing light from a light source to emerge from a light guide plate in a direction opposite to a predetermined illumination direction;
receiving light from the light guide plate, regulating a direction of the light by a first beam direction regulator, and emitting the light;
reflecting light from the first beam direction regulator by a reflecting member and transmitting the light through the first beam direction regulator and the light guide plate; and
causing light emerging from the light guide plate to emerge from a transmittance/scattering switching device and switching between a state for transmitting and a state for scattering light.

18. A display apparatus comprising the illumination apparatus according to claim 1 and a display panel.

19. The display apparatus according to claim 18, wherein the display panel is a liquid crystal display panel.
